(19) United States
(12) Patent Application Publication
(10) Pub. No.: US 2025/0166266 A1
(43) Pub. Date: May 22, 2025

(54) SYSTEMS AND METHODS FOR DEFECT IMAGE GENERATION USING DIFFUSION MODEL SAMPLING

(71) Applicant: Samsung Display Co., Ltd., Yongin-si (KR)

(72) Inventors: Zhihong Pan, San Jose, CA (US); Rahul Shenoy, San Jose, CA (US); Kaushik Balakrishnan, Fremont, CA (US); Qisen Cheng, Sunnyvale, CA (US); Janghwan Lee, Pleasanton, CA (US)

(21) Appl. No.: 18/949,390

(22) Filed: Nov. 15, 2024

Related U.S. Application Data
(60) Provisional application No. 63/600,516, filed on Nov. 17, 2023.

(51) Int. Cl. G06T 11/60; G06T 5/60; G06T 5/70; G06T 7/00

(52) U.S. Cl. CPC G06T 11/60; G06T 5/60; G06T 5/70; G06T 7/001; G06T 2207/20081; G06T 2207/20084; G06T 2207/30108; G06T 2207/30168

(57) ABSTRACT

A system and a method are disclosed for defect image generation using diffusion model sampling. The method includes generating, by a processor via a diffusion model, a noisy image from a defect-free image, generating, by the processor via the diffusion model, a sampled defect image and a sampled defect-free image from the noisy image, generating, by the processor, a mask based on the sampled defect image and the sampled defect-free image, generating, by the processor, a synthetic defect image by generating an additional sampled defect image based on the noisy image and the mask, and transmitting, by the processor, the synthetic defect image.

### CROSS-REFERENCE TO RELATED APPLICATION

This application claims the priority benefit under 35 U.S.C. § 119 (e) of U.S. Provisional Application No. 63/600,516, filed on Nov. 17, 2023, the disclosure of which is incorporated by reference in its entirety as if fully set forth herein.

### TECHNICAL FIELD

The disclosure generally relates to machine learning. More particularly, the subject matter disclosed herein relates to defect classification based on artificial intelligence.

### SUMMARY

Production of products (e.g., electronic devices, such as television and mobile display devices) continues to increase. To keep up with the mass production of devices, it may be suitable to improve manufacturing techniques and efficiencies, for example, by detecting, classifying, and repairing defects in products (e.g., defects in the circuitry of a product). Improved techniques may include leveraging artificial intelligence (AI) and machine learning (ML) in such processes. However, it may be difficult to improve manufacturing processes for some new products because the number of defect samples in manufacturing may be a small subset of the total (e.g., 1-2% of the total), and therefore may hinder the development of a defect detection classifier (e.g., a robust defect detection classifier).

To solve this problem, AI-based generative models may be utilized. For example, AI generative models may learn a data distribution of defect-free samples and defect samples (e.g., defective samples) from source products and may transfer defects associated with the defect samples to defect-free images from target products to create synthetic images for the target products. This may be advantageous for classifying defects related to target products that are relatively new (e.g., newer than the source products). For example, a new product (e.g., a new target product) may have been introduced into production relatively recently and, as such, there may be insufficient defect images available for suitable machine learning. Synthetic defect images for a target product may allow for improved machine learning. As used herein, a “synthetic defect image” refers to a digitally generated and/or artificially simulated image that shows defects that may occur during the manufacturing of the product. Additionally, as used herein, a “synthetic defect” refers to an artificially generated (e.g., fake) defect in an image (e.g., synthetic defect image) used to simulate the types of defects and/or flaws that may occur during the manufacturing of a product.

However, there may be inaccuracies and/or inconsistencies related to generating synthetic defect images. For example, there may be low quality and/or clarity of the background in a synthetic defect image generated using diffusion model sampling without any form of masking. Additionally, problems may arise related to synthetic defect images that are generated utilizing manual masking. As used herein, a “diffusion model” refers to a type of machine-learning model that adds noise (e.g., random noise) to input data (e.g., an input image) to train a denoising model, and then reverses the noise-adding process (e.g., denoises the image) to generate new data (e.g., an output image) at application. As used herein, “NG” refers to a product defect (e.g., a product that has some aspect that is not good or that is not acceptable). Manual masking may lead to issues such as defects that are generated inaccurately (e.g., wrong size, shape, location, etc.) in the synthetic defect image and/or a failure to generate any defect in a synthetic defect image.

To overcome these issues, systems and methods are described herein for implementing diffusion model sampling and automatic masking for AI models (e.g., machine-learning models) to learn defects from defect-free images (e.g., images of products that are acceptable) and defect images (e.g., images of products that are defective and, therefore, not acceptable).

In some embodiments, for each of one or more early diffusion sampling steps, two predictions may be generated from a diffusion model, using OK and NG conditions, respectively. In some embodiments, the differences between these predictions from each of the one or more early diffusion sampling steps may be used to determine a mask automatically. In some embodiments, the mask may be applied in the following (e.g., the subsequent) diffusion steps to limit the defect generation in a determined area.

The above approaches may improve on previous methods by automatically generating and applying a mask during the diffusion model sampling process such that generated defects in the synthetic defect images are focused to (e.g., focused on) a specific location in the image (e.g., defined by the mask). Additionally, the approaches improve on previous methods by replacing areas in synthetic defect images that are outside of the mask with a background (e.g., a high-quality background) from real defect-free images. Aspects of some embodiments of the present disclosure may allow for improved accuracy and/or improved efficiency in generating synthetic defect images.

In some embodiments, a method includes generating, by a processor via a diffusion model, a noisy image from a defect-free image, generating, by the processor via the diffusion model, a sampled defect image and a sampled defect-free image from the noisy image, generating, by the processor, a mask based on the sampled defect image and the sampled defect-free image, generating, by the processor, a synthetic defect image by generating an additional sampled defect image based on the noisy image and the mask, and transmitting, by the processor, the synthetic defect image.

The defect-free image may include a real defect-free image of a target product.

The generating the sampled defect image may include sampling the diffusion model based on a first class label set to a defect label.

The generating the sampled defect-free image may include sampling the diffusion model based on a second class label set to a defect-free label.

The generating the sampled defect image and the sampled defect-free image may include sampling the diffusion model for a set of time steps in an iterative process.

The generating the mask may include determining a difference between the sampled defect image and the sampled defect-free image.

The generating the synthetic defect image may include generating a defect within a location defined by the mask and overlaying the mask over the additional sampled defect image.

The generating the synthetic defect image may include replacing a background of the synthetic defect image outside of a location defined by the mask.

The replacing the background of the synthetic defect image may be performed based on the defect-free image.

The synthetic defect image may include a synthetic defect image of a target product and the defect-free image of the target product.

The generating the synthetic defect image may include denoising an amount of noise within a location defined by the mask.

The denoising may be performed for the additional sampled defect image for a set of time steps.

The diffusion model may be trained based on a real defect-free image and a real defect image.

The real defect-free image and the real defect image may be associated with a source product.

In some embodiments, a device includes one or more processors that are configured to perform generating a sampled defect image and a sampled defect-free image from a noisy image using a diffusion model, generating a mask based on the sampled defect image and the sampled defect-free image, generating a synthetic defect image by generating an additional sampled defect image based on the noisy image and the mask, and transmitting the synthetic defect image.

The one or more processors may be configured to perform the generating the sampled defect image by sampling the diffusion model using a first classification set to a defect label.

The one or more processors may be configured to perform the generating the sampled defect-free image by sampling the diffusion model using a second classification set to a defect-free label.

The one or more processors may be configured to perform the generating the sampled defect image and the sampled defect-free image by sampling the diffusion model for a set of time steps in an iterative process.

The one or more processors may be configured to perform the generating the mask by determining a difference between the sampled defect image and the sampled defect-free image, and the generating the synthetic defect image by generating a defect within a location defined by the mask.

In some embodiments, a system includes a processing circuit, and a memory storing instructions, which, based on being executed by the processing circuit, cause the processing circuit to perform generating a noisy image from a defect-free image based on a diffusion model, generating a sampled defect image and sampled defect-free image from the noisy image based on the diffusion model, generating a mask based on the sampled defect image and the sampled defect-free image, generating a synthetic defect image by generating an additional sampled defect image based on the noisy image and the mask, and transmitting the synthetic defect image.

### BRIEF DESCRIPTION OF THE DRAWING

In the following section, the aspects of the subject matter disclosed herein will be described with reference to exemplary embodiments illustrated in the figures.

FIG. 1 is a block diagram depicting a system (e.g., a factory) for producing products (e.g., electronic devices, such as organic light-emitting diode (OLED) devices), according to some embodiments of the present disclosure.

FIG. 2A is an example defect-free image of a source product, FIG. 2B is an example defect image of the source product, FIG. 2C is an example defect-free image of a target product, and FIG. 2D is an example defect image of the target product, according to some embodiments of the present disclosure.

FIG. 3 is a flow chart depicting example operations of a method for generating fake defect images to train a classifier model of FIG. 1 that can be deployed in the factory and used to perform inspections, according to some embodiments of the present disclosure.

FIG. 4A is a diagram depicting a neural network of a diffusion model, according to some embodiments of the present disclosure.

FIG. 4B is a diagram depicting a method for training the diffusion model of FIG. 4A based on a source product, according to some embodiments of the present disclosure.

FIG. 4C is a diagram depicting a method for sampling (or generating) synthetic defect images from the diffusion model of FIG. 4A, according to some embodiments of the present disclosure.

FIG. 5 is a block diagram depicting a computer device for defect image generation, including a diffusion model sampling circuit implementing automatic masking, according to some embodiments of the present disclosure.

FIG. 6 is a flow chart depicting example operations of a method for synthetic defect image generation using diffusion model sampling, and including automatic masking, according to some embodiments of the present disclosure.

FIG. 7 is a block diagram of an electronic device in a network environment 700, according to some embodiments of the present disclosure

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in some embodiments (e.g., in one or more embodiments). In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

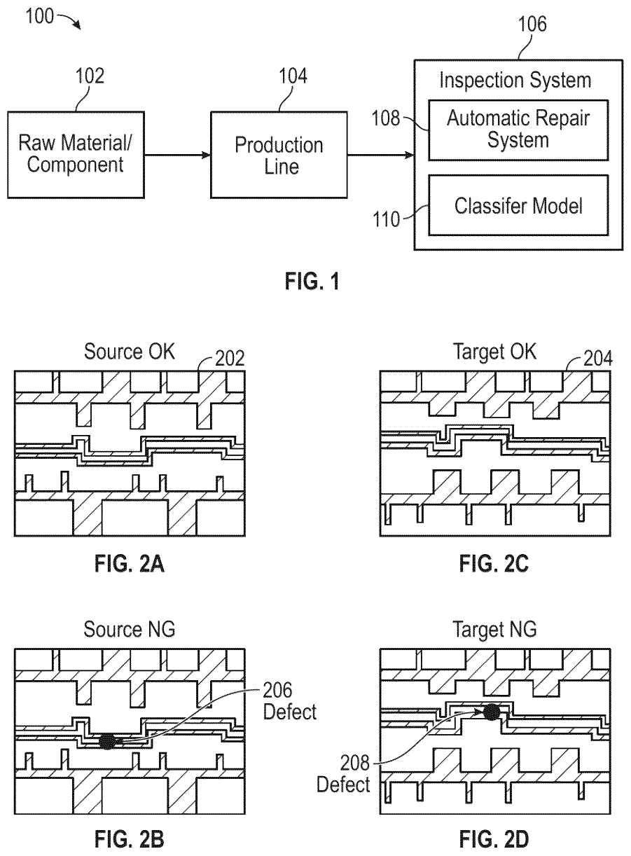

FIG. 1 is a block diagram depicting a system 100 (e.g., a factory) for producing products (e.g., electronic devices, such as organic light-emitting diode (OLED) devices), according to some embodiments of the present disclosure.

Manufacturing products (e.g., in a factory or a production line) may include various processes to ensure certain quality standards are satisfied. In some embodiments, the system 100 (e.g., the factory) of FIG. 1 may produce products (e.g., electronic devices, such as display devices, integrated circuits, and/or the like). As seen in FIG. 1, the system 100 may include a production line 104. The production line 104 may include machines, machinery, and/or devices that take raw materials and/or components 102 as inputs and assembles, constructs, and/or produces one or more products, such as the display devices (e.g., OLED devices). At an output of the production line 104, an inspection system 106 (e.g., a system for performing inspection processes) may be implemented to conduct quality assurance (e.g., quality control) by looking for defects in the products or portions of the products (e.g., in the circuitry) and by classifying the defects. As used herein, a “defect” refers to some type of abnormality in a product (e.g., a device) that may be identified by an image. For example, the inspection system 106 may capture images of product defects. In some embodiments, the system 100 may provide data for repairing the defects. In some embodiments, the system 100 may perform repair processes to repair the defects. For example, in some embodiments, the inspection system 106 may implement an automatic repair system 108 that enables functions related to repairing defects that may have been detected in OLED devices during inspection. The inspection system 106 may perform the functions of the automatic repair system 108 implemented therein, including, but not limited to: laser repair; material deposition; electrical circuit reconfiguration; verification; re-testing; and/or the like, without manual intervention (e.g., without significant manual intervention). In some embodiments, the inspection system 106 may implement capabilities (e.g., enhanced capabilities) related to defect classification for OLED devices, such as defect generation utilizing diffusion model sampling with masking (e.g., automatic masking).

It may be desirable to identify defects in a manufacturing process (e.g., in a mobile display OLED manufacturing process) with high accuracy for improved efficiency and robustness (e.g., improved quality). In some systems, defect identification, classification, and repair process may be undertaken by human personnel in a Remote Operator System (ROS). For example, the human personnel may operate an auto repair process remotely. Such an approach may be relatively costly as it may involve a significant number (e.g., a large number) of human operators in the defect identification and defect repair stages. Such an approach may also be relatively time consuming and/or prone to human error, which may make the overall system inefficient. To improve the manufacturing process, in some embodiments, an AI-based defect classification and repair system may be utilized. To build an AI-based classifier model 110, it may be desirable to have a data balance between a number of defect-free images and a number of defect images used to train an AI model for AI-based classification. Achieving a suitable data balance may be difficult because a number of defect samples in manufacturing may make up a very small subset of the total samples (e.g., 1-2% of the total), and therefore may hinder the development of a suitable (e.g., a robust) classifier model 110 for defect detection.

Aspects of some embodiments of the present disclosure provide for an AI-based generative model to mitigate (e.g., to overcome) the data-balance problem. For example, in some embodiments, an AI generative model may be generated, trained, and/or utilized by the inspection system 106 to learn the data distribution of defect-free (OK) images and defect samples (e.g., NG-1/NG-2/NG-3/ . . . ) from source products and transfer defects associated with the defect samples to defect-free images from target products to create synthetic NG-k (k=1, 2, 3, . . . ) images for the target products. The number of defect types detected by the inspection system 106 may be large (e.g., greater than 20 different types of defects), and therefore each type of defect may be distinguished as NG-1, NG-2, NG-3, and so on. The defects may appear in different shapes, sizes, and locations (e.g., location with respect to the background circuitry that is being inspected).

As used herein, the term “source” or “source products” refers to products that have been in production (e.g., mass production) for a relatively long time (e.g., more than one year), such that a suitable number (e.g., a large corpus) of manufacturing defect images is available for training a machine-learning model to recognize defects in the source products. As used herein, the term “target” or “target products” refers to those products that are relatively new. For example, target products may include products introduced into production relatively recently and, therefore, sufficient defect images from the target products may not be available for suitably training a machine-learning model to recognize defects in the target products. Thus, a lack of a sufficient quantity of defect images may hinder the development of classifiers for detecting defects (e.g., in an automatic-repair system). Aspects of some embodiments of the present disclosure provide for an AI-based generative model to learn the defect distribution from the source products and transfer the defects from source products to target products, thereby creating fake (e.g., synthetic) defect images for the target products. In some embodiments, variations in the defects may be learned by the generative model so that good quality fake NG-k (k=1, 2, 3, . . . ) images can be generated by the AI model. In some embodiments, the AI model may generate synthetic defect images where the locations of the defects are consistent with respect to product patterns (e.g., circuit patterns) in the background. In some embodiments, AI models may be trained using sample synthetic images having a suitable (e.g., a suitably high) image resolution.

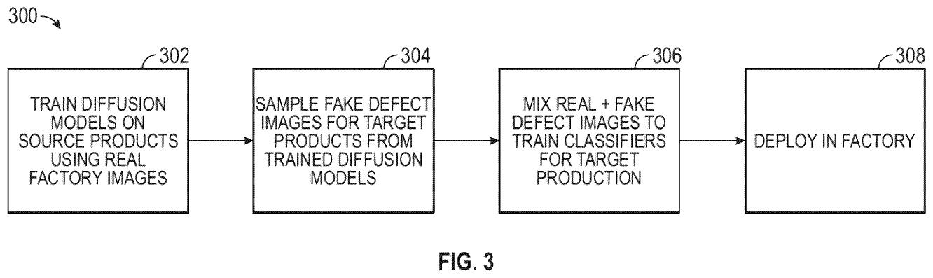

FIG. 2A is an example defect-free image of a source product, FIG. 2B is an example defect image of the source product, FIG. 2C is an example defect-free image of a target product, and FIG. 2D is an example defect image of the target product, according to some embodiments of the present disclosure.

FIG. 2A is an example defect-free image of a source product because there is no presence of a defect in the image, FIG. 2B is an example defect image of the source product because there is a defect 206 present in the image, FIG. 2C is an example defect-free image of a target product because there is no presence of a defect in the image, and FIG. 2D is an example defect image of the target product because there is a defect 208 present in the image. The defect may result from the production line 104 (see FIG. 1). For example, a malfunctioning of a component or of a manufacturing process may cause a defect in in the product. In the case of a defective electronic device or defective circuitry, the defect may include, for example, a faulty short circuit or a faulty open circuit in wiring or traces on a circuit board or between layers of a semiconductor. For example, FIG. 2A shows a close-up view of a portion of an example circuit board illustrating traces 202 (e.g., circuit patterns) of a source product (e.g., a source device) that is defect free (e.g., that is acceptable). Similarly, FIG. 2C shows a close-up view of a portion of an example circuit board illustrating traces 204 of a target product (e.g., a target device) that is defect free.

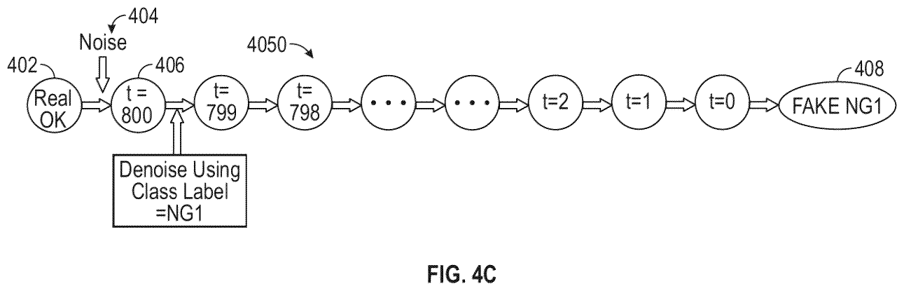

As can be seen by comparing FIG. 2A with FIG. 2C, although the target product of FIG. 2C is not identical to the source product of FIG. 2A, there may be some similarities between the source product and the target product. Based on the similarities between the source product and the target product, in some embodiments, a generative-AI system may be used to take (e.g., to capture) one or more defect images from the source product and generate one or more synthetic defect images for the target product. The process of generating synthetic defect images for the target product based on defect images from the source product may be used to generate a sufficient amount of defect images so that an AI-classifier model (e.g., shown in FIG. 1) for the target product may be trained so that it can classify images. In some embodiments, the AI-classifier model may be trained to repair defects (e.g., to repair defects automatically). In some embodiments, a neural network of the diffusion model may be trained from the source product such that the trained neural network can be used to take defect-free images 402 (e.g., defect-free images) (see FIG. 4C) of the target product (e.g., target device) and generate synthetic defect images 508 (e.g., synthetic defect images) (see FIG. 4C) of the target product. In other words, the defect image of the source product, such as the image depicted in FIG. 2B, may be used to train the neural network such that the neural network may be used to generate a synthetic defect image of the target product, such as the image depicted in FIG. 2D. Therefore, even though the image of the target product does not have a defect (as shown in FIG. 2C), a “synthetic” (e.g., artificial and/or fake) defect 208 may be generated on the image of the target product as shown in FIG. 2D.

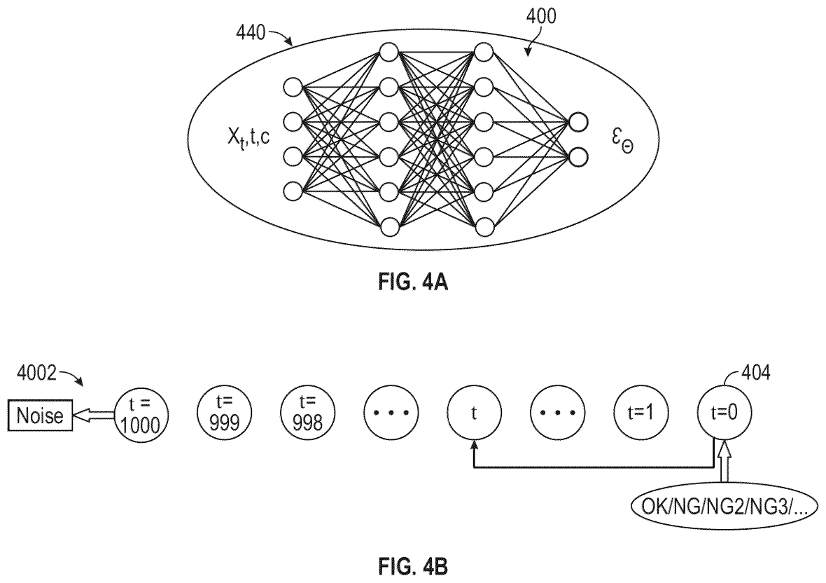

FIG. 3 is a flow chart depicting example operations of a method for generating fake defect images to train the classifier model of FIG. 1 that can be deployed in the factory and used to perform inspections, according to some embodiments of the present disclosure.

Referring to FIG. 3, various operations are illustrated in the method 300 for generating synthetic defect images to train a classifier model (e.g., shown in FIG. 1). Nonetheless, some embodiments according to the present disclosure are not limited thereto, and according to some embodiments, the number or order of operations in method 300 may vary. For example, some embodiments may include additional operations or fewer operations, or the order of operations may vary, unless otherwise stated or implied, without departing from the spirit and scope of embodiments according to the present disclosure. In some embodiments, the inspection system 106 (shown in FIG. 1) may implement the method 300.

In some embodiments, a diffusion model 440 (see FIG. 4A), which is a type of generative model, may be used to generate synthetic images (e.g., synthetic defect images). In some embodiments, the diffusion model 440 may be trained using real images and/or synthetic images from a source product in a factory (operation 302). For example, high resolution images may be captured by the inspection system 106 (see FIG. 1) following the production of various components or elements of a device, and such images may be used to train the diffusion model 440. In some embodiments, the diffusion model 440 made be trained using (e.g., based on) a defect-free image of the source product (e.g., see FIG. 2A), and real and/or synthetic defect images 508 of the source product (e.g., see FIG. 2B).

The trained diffusion model 440 (see FIG. 4A) may then be used to generate synthetic (e.g., artificial and/or fake) defect images of a target product from defect-free images of the target product (operation 304). For example, the target product may not have a sufficient number of defect images that can be used to train a classifier model (e.g., shown in FIG. 1), and therefore may rely on a diffusion model 440 that was trained on a source product to generate synthetic defect image using generative AI. Such defects may correspond to, in the case of electronic devices, faulty short circuits or faulty open circuits in the electronic devices. For example, a short circuit may occur in production of a product when unintended connections form conductive layers or components, causing a path for current that bypasses the intended circuit. Examples of short circuits that may lead to defects in a product may include but are not limited to: electrode layer shorts; thin film shorts; particle-induced shorts; and/or the like. In another example, an open circuit may occur in production of a product when there is an unintended break and/or discontinuity in the electrical pathway, potentially preventing current flow and resulting in non-functional parts. Examples of open circuits that may lead to defects in a product may include but are not limited to: broken electrodes; faulty wiring and/or interconnects; disrupted connection (e.g., in thin film layer); substrate defects; and/or the like. The trained diffusion model 440 may be trained to generate synthetic defect images relating to short circuits, for instance, that may be experienced during manufacturing of a target product, The synthetic defect images generated by the diffusion model 440 may then be used to train a classifier model (e.g., shown in FIG. 1) for the target product, although there are no and/or few real defect images that are available for the target product of defects that were detected in the real world (e.g., in newly manufactured product).

Referring still to FIG. 3, once a desired amount of synthetic defect images are generated from diffusion model sampling, then real defect images and/or synthetic defect images may be used (e.g., may be mixed) to train a classifier model (e.g., shown in FIG. 1) (operation 306) of the target product. In some embodiments, the classifier may be a machine-learning model that is trained utilizing: real defect-free images 402 of the source product and real defect-free images 402 of the target product; synthetic defect images of the source product and synthetic defect images of the target product; and/or real defect images of the source product. In other words, the real and synthetic defect images, along with the defect-free images, may become the training data with which a classifier model for a target product may train itself. Once the classifier model is trained, the classifier model may be deployed in an inspection system 106 in a factory (operation 308). Once deployed, in some embodiments, the inspection system 106 may utilize the classifier model as a multi-class classifier model to perform inspections and/or to perform automatic repair functions on products that come out of the production line in the factory.

FIG. 4A is a diagram depicting a neural network 400 of a diffusion model 440, according to some embodiments of the present disclosure.

FIG. 4B is a diagram depicting a method 4002 for training the diffusion model 440 of FIG. 4A based on a source product, according to some embodiments of the present disclosure.

Although FIG. 4B illustrates various operations in a method for training a multi-class diffusion model 440, some embodiments according to the present disclosure are not limited thereto, and according to some embodiments, the number or order of operations may vary. For example, some embodiments may include additional operations or fewer operations, or the order of operations may vary, unless otherwise stated or implied, without departing from the spirit and scope of some embodiments according to the present disclosure. The method 4002 (e.g., the diffusion training process) may be illustrated based on a sequence of a number (e.g., a set number) of steps t (e.g., time steps). For example, the time steps t may include T number of time steps, where T=1000 (e.g., number of time steps). Each time step may correspond to a next step or a previous step without corresponding to a specific duration of time (e.g., each time step may not correspond directly to a specific amount of time, such as seconds). In some embodiments, the steps t may correspond to a noise-level range associated with an image. For example, the image may have no noise at time step t=0 to an image at time step t=1000 that is extremely noisy (e.g., pure noise). The images between step t=0 and step t=1000 may have a gradually increasing amount of noise (e.g., Gaussian noise) such that the image at step t=1 may have a little bit of noise added to the image at step t=0, the image at step t=2 may have a little bit more noise in addition to the image at step t=1, and so on until the image at step t=1000 has extreme noise (e.g., pure noise). In some embodiments, the neural network 400 may be trained such that the amount of noise that is added at each step t is known. In some embodiments, the neural network 400 may predict the amount of noise that is present in the image at any step t, and therefore, the noise may be removed to reveal or generate a purely noiseless image. In some embodiments, the diffusion model 440 may be based on a standard latent diffusion model (LDM) using a convolutional neural network (CNN) backbone architecture (e.g., using a U-Net CNN backbone architecture). In some embodiments, the training may follow a standard procedure of diffusion (e.g., stable diffusion) known to one of ordinary skill in the art. For example, an autoencoder may be utilized to project data from pixel to latent space, where the diffusion model 440 may be trained. In some embodiments, a learned perceptual image patch similarity (LPIPS) loss may be used to train the diffusion model 440.

FIG. 4C is a diagram depicting a method for sampling (or generating) synthetic defect images from the diffusion model of FIG. 4A, according to some embodiments of the present disclosure. Although FIG. 4C illustrates various operations in a method 4050 for generating synthetic defect images 408 from a diffusion model 440 (e.g., multi-class model), some embodiments according to the present disclosure are not limited thereto, and according to some embodiments, the number or order of operations may vary. For example, some embodiments may include additional operations or fewer operations, or the order of operations may vary, unless otherwise stated or implied, without departing from the spirit and scope of some embodiments according to the present disclosure. In some embodiments, the method 4050 illustrated in FIG. 4C may generate synthetic defect images 408 using diffusion model sampling and automatic masking aspects. In some embodiments, the diffusion model 440 may be used to take a defect-free image 402 from a target product (e.g., a target device) and generate a synthetic defect image 408 from the defect-free images 402 based on the neural network 400 (e.g., shown in FIG. 4A) that was built and trained from the source product (e.g., the source device).

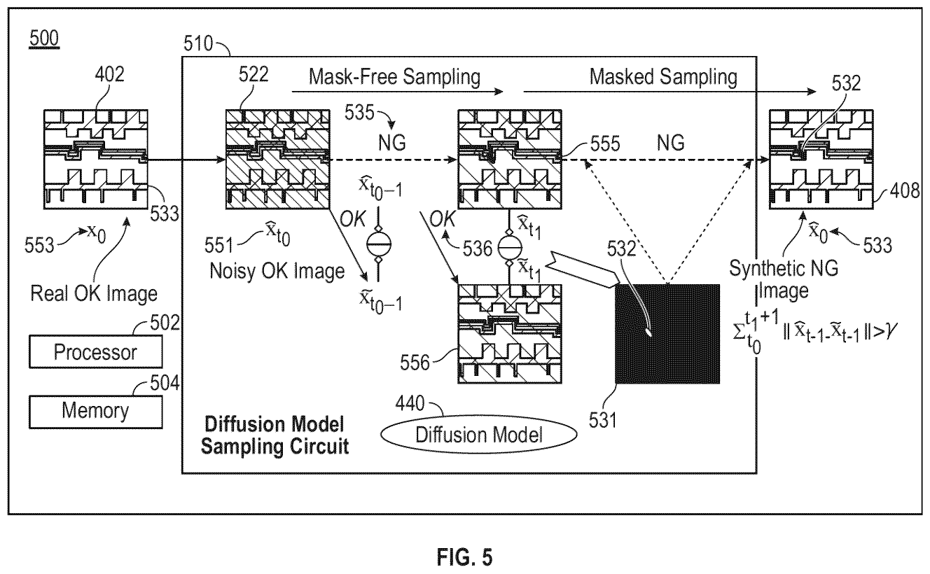

In some embodiments, the trained neural network 400 (e.g., shown in FIG. 4A) includes an input with variables Xt, t, and c, wherein Xt corresponds to a partially noisy image at time step t, t corresponds to the time step t, and c corresponds to a class label that may indicate to the neural network whether to generate an OK image (e.g., a defect-free image) or one or more classes of NG images (e.g., defect images). Thus, by setting the class label c to OK (e.g., defect-free) label 536 (see FIG. 5), a defect-free image 402 may be generated by the neural network 400 (e.g., shown in FIG. 4A). Similarly, by setting the class label to a label NG 535 (e.g., a defect label) (see FIG. 5), an NG-1 image corresponding to a first type of defect image may be generated by the neural network 400 (e.g., shown in FIG. 4A), and by setting the class label to NG-2, an NG-2 image corresponding to a different type of defect image may be generated by the neural network 400 (e.g., shown in FIG. 4A).

In some embodiments, the above-described trained neural network 400 (e.g., shown in FIG. 4A) may be utilized on other devices (e.g., target devices) that do not necessarily have enough data to train their own neural network to generate defect images. In some embodiments, by setting the class label c to NG-1 or NG-2 or NG-3, a desired defect image for the target device may be generated by the neural network trained from the source product (e.g., source device).

According to some embodiments, the sampling process may start by taking a defect-free image 402 of the target device, and noise 404 (e.g., Gaussian noise) corresponding to some intermediate time step (e.g., time step t=800) may be added to the defect-free image 402 to generate a noisy OK image 546. Once noise has been added to the image, the class label c may be set to the desired defect class, for example NG-1, and the noise may be removed by using the diffusion model 440 (See FIG. 4A) in order generate the synthetic defect image 408 (e.g., using class NG-1). It should be understood that, while there are 1000 steps t depicted in FIG. 4A for the training process 4002, the sampling method 4050 (e.g., as shown in FIG. 4C) may start at step t=800 because the images at approximately steps t=800 to t=1000 may include mostly noise, with the background substantially destroyed. Therefore, the method 4050 implementing sampling may skip those portions (e.g., may skip the noisiest steps) and start denoising from an intermediate step t (e.g., an arbitrarily determined intermediate step t), such as around step t=800, thus bypassing the images with substantial noise and instead utilize the images that have some noise and some background information. Next, in some embodiments, some of the noise from the noisy image at step t=800 may be denoised (e.g., removed), which results in the noisy image at step t=799. This process may be continued by again denoising some of the noise from the noisy image at step t=798, which results in the noisy image at step t=798. Thus, after each denoising step, a clearer image may be generated. Through (e.g., based on) these denoising steps, an image corresponding to the defect image selected by the class label (e.g., NG-1) may be generated, which is the synthetic defect image 408 (e.g., the fake defect image). Therefore, if the class label was set to NG-1, then the denoised imaged at step t=0 may be a synthetic defect image of class NG-1. It should be understood that, although the intermediate step is set at step t=800 for the example of FIG. 4C, the present disclosure is not limited thereto. For example, any other suitable intermediate step t may be used as the starting point for the sampling process.

There may be inaccuracies and/or inconsistencies related to generating synthetic defect images. For example, there may be low quality and/or clarity of the background in a synthetic defect image generated using diffusion model sampling without any form of masking, for example. Synthetic defect images with low quality backgrounds may cause the traces in these areas (e.g., background areas) of the images to be distorted. Training a diffusion model 440 using such synthetic defect images (e.g., low quality and/or clarity background) may lead to poor performance of the model, such as product confusion. As used herein, “product confusion” refers to situations involving a model mistakenly identifying and/or classifying a product based on the traces throughout (e.g., in the background) of the image. Consequently, in such cases, the diffusion model 440 may generate a defect 532 with accuracy in the synthetic defect image, but the background patterns in the image may be incorrect because of the product confusion. There may be other limitations, errors, and/or inaccuracies related to defect generation without masking, in addition to those described herein.

Additionally, problems may arise related to synthetic defect images 408 that are generated utilizing manual masking. Manual masking may lead to issues such as defects that are generated inaccurately (e.g., wrong size, shape, location, etc.) in the synthetic defect image 408 and/or a failure to generate any defect in a synthetic defect image 408. As used herein, “manual masking” refers to a process involving a human (e.g., engineer, etc.) defining the specific regions and/or locations on an OLED layer where the simulated defects are to be generated in the synthetic image. Generating a defect in a location and/or area of a synthetic defect image 408 that may not be experienced in the real-world as a real defect during manufacturing of a product may further propagate the inaccuracy. For example, the overall accuracy and/or precision of a classification model trained on such synthetic defect images 408 (e.g., inaccurate defect location) can be degraded, and further lead to errors and/or faults in the inspection system (e.g., reduced defect detection). Moreover, manual masking may experience drawbacks related to manual processes, such as inefficiency (e.g., slowness, low repeatability, etc.) with large data sets, and limitations based on the expertise of a human. There may be other limitations, errors, and/or inaccuracies related to defect generation using manual masking, in addition to those described herein. Therefore, some embodiments of the present disclosure are directed to techniques for implementing diffusion model sampling using an automatic masking method (e.g., a distinct automatic masking method) to improve the accuracy and/or efficiency of the generation of synthetic defect images 408.

FIG. 5 is a block diagram depicting a computer device 500 for defect image generation, including a diffusion model sampling circuit 510 implementing automatic masking, according to some embodiments of the present disclosure.

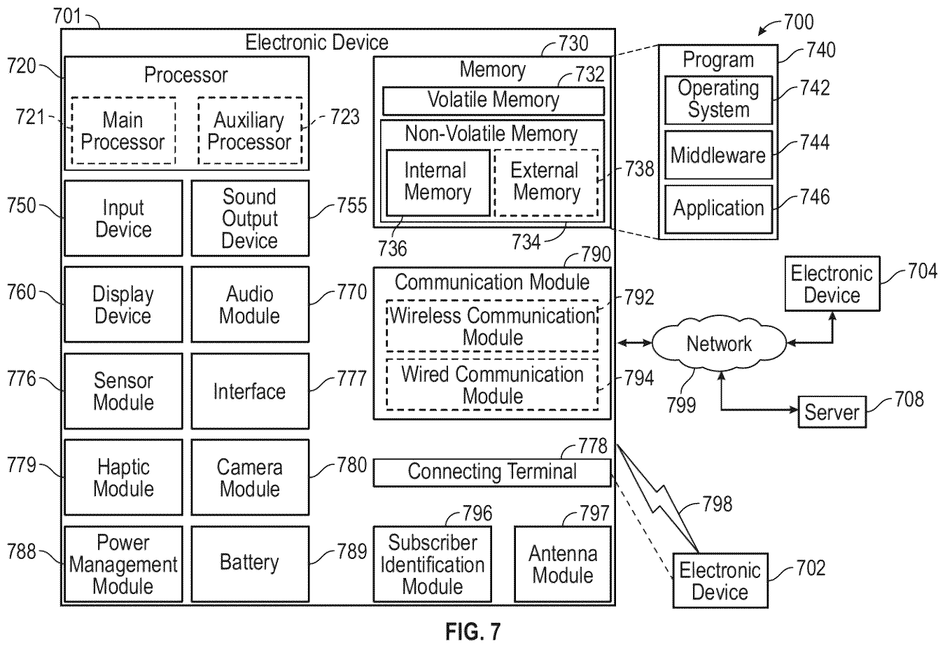

As illustrated in FIG. 5, the computer device 500 (e.g., one or more computers and/or one or more computer systems) may include a memory 504 (e.g., a memory and/or a storage), a processor 502, and a diffusion model sampling circuit 510 configured for implementing the generation of synthetic images, such as synthetic defect image 408, utilizing automatic masking, as disclosed herein. The memory 504 may correspond to the memory 730 of FIG. 7. The processor 502 may correspond to the processor 720 of FIG. 7 As a general description, the diffusion model sampling circuit 510 may execute one or more functions related to diffusion model sampling, as disclosed herein, which may involve generating a noisy image 522 from a defect-free image 402 of a target product (described in reference to FIG. 4A), and iteratively denoising the noisy image 522 to generate an image corresponding to the defect image selected by the class label NG 535 (e.g., defect class), which is the synthetic defect image 408 (e.g., described with reference to FIG. 4C) of the target product.

Furthermore, the diffusion model sampling circuit 510 may implement automatic masking during the aforementioned diffusion model sampling process, enabling a mask 531 to be automatically generated and applied during the denoising phase to generate the defect 532 in a specified area of the synthetic defect image 408 (e.g., within the mask 531) in a manner that preserves a high quality (e.g., high resolution) background 533 (e.g., background from the real defect-free image 402) for the synthetic defect image 408 in a manner that enhances it to have improved clarity and/or accuracy. According to some embodiments, the computer device 500 may utilize AI models (e.g., diffusion model 440) that were generated and/or trained by receiving one or more of the higher quality synthetic defect images 408 generated by the diffusion model sampling circuit 510, thus experiencing improved accuracy, efficiency, and/or precision (e.g., accurate defect detection).

As used herein, a “mask” refers to a tool used to generate synthetic defects within an image that may include parameters to specify and/or modify characteristics relating to the generated defect (e.g., location, shape, size, intensity, etc.). For example, the diffusion model sampling circuit 510 may generate the mask 531 indicating an area and/or location of the defect 532 in an image with respect to the background 533 (e.g., traces of circuitry being inspected not corresponding to the defect and/or defect area). In some embodiments, the diffusion model sampling circuit 510 may automatically (e.g., without human interaction) generate the mask 531 during the diffusion model sampling process by denoising utilizing a defect class, NG label 635 (e.g., NG-1) and a non-defect class label, OK label 636 (e.g., OK). Subsequently, the diffusion model sampling circuit 510 may apply the generated mask 531 to the remaining steps of the diffusion model sampling process to focus generating the defect 532 within a particular location and/or area of the image (e.g., based on the mask 531) for improved accuracy, while retaining a high-quality background 533 from the real defect-free images 402. In some embodiments, by employing the diffusion model sampling circuit 510, as disclosed herein, the computer device 500 may generate, train, and/or utilize AI models with enhanced detection accuracy, and improved adaptability to evolving target products and/or defect types without using a dataset of real images of defects of the target product (e.g., diffusion model 440 trained on images of source product).

The computer device 500 may include a computer system that is capable of AI-related functions including model training, computations, inference, and various AI-based applications. For example, the computer device 500 may be implemented as, for example, and without limitation, a desktop PC, a laptop, a smartphone, a tablet PC, a server, and/or the like. The computer device 500 may also refer to a system in which a cloud computing environment is established. However, some embodiments are not limited thereto. The computer device 500 may be implemented as any system, device, or apparatus which is capable of AI-based applications and functions (e.g., defect generation, diffusion model sampling, etc.) as described herein. In some embodiments, the computer device 500 may implement various functions (e.g., defect detection, automatic repair, etc.) related to manufacturing and/or inspection of an OLED device, such as an inspection system 106 (e.g., shown in FIG. 1). For example, the computer device 500 may employ AI capabilities to detect defects in real images of a target product during inspection in manufacturing, based on the higher quality synthetic defect image 408 of the target product. The computer device 500 may include one or more processors for performing one or more of the processes of the present disclosure.

In some embodiments, the memory 504 may store data and/or AI models associated with AI-based applications, as disclosed herein (e.g., inspection, synthetic defect image generation, defect detection, etc.), including diffusion model 440. In some embodiments, the memory 504 may store models generated, trained, and/or utilized by the diffusion model sampling circuit 510. In some embodiments, the memory 504 may store the enhanced synthetic defect images 408 generated by the diffusion model sampling circuit 610, and utilizing diffusion model sampling including automatic masking, as disclosed herein.

In some embodiments, the processor 502 may include various processing circuitry and may control overall operations of the computer device 500, including AI-based applications supported by the AI models (e.g., diffusion model 440) generated, trained, and utilized by the diffusion model sampling circuit 510, as disclosed herein. In some embodiments, the processor 502 may include various processing circuitry (e.g., one or more processing circuits) and may control overall operations of the computer device 500 (e.g., the computer system), including AI-based applications supported by the synthetic defect images 408 generated by the diffusion model sampling circuit 510 (e.g., utilizing automatic masking), as disclosed herein. In some embodiments, the processor 502 may be implemented, for example, and without limitation, as a digital signal processor (DSP), a microprocessor, or a time controller (TCON), or the like, but is not limited thereto. The processor 502 may, for example, and without limitation, be one or more of a dedicated processor, a central processing unit (CPU), a micro controller unit (MCU), a micro processing unit (MPU), a controller, an application processor (AP), a communication processor (CP), an ARM processor, or the like, or may be defined as one of the terms above. Also, the processor 502 may be implemented as a system on chip (SoC) in which a processing algorithm is provided, or may be implemented in a form of a field programmable gate array (FPGA), or the like, but is not limited thereto.

Referring to FIG. 5, in some embodiments, the diffusion model sampling circuit 510 may implement the generation of synthetic defect images 408 using diffusion model sampling including automatic masking, as disclosed herein. In some embodiments, the diffusion model sampling circuit 510 may generate, train, and/or utilize the diffusion model 440 to take a real defect-free image 402 of a target product and generate a synthetic defect image 408 from the defect-free image 402 using processing capabilities of the diffusion model 440 (e.g., implemented by neural network 400 in FIG. 4A that was built and trained from the source product).

In some embodiments, the diffusion model sampling circuit 510 may utilize variables x₀ 650 denoting the defect-free image 402, t₀ denoting the time step for initiating denoising phase (e.g., including mask 531 generation), t₁ denoting the time step for initiating masking phase; \hat{x}ₜ_{₀} 653 denoting the partially noisy image at time step t=t₀, t denoting the time step; and t=0 denoting the time step of complete generation of synthetic defect image 408. In some embodiments, a class label may indicate to the diffusion model 440 whether to generate a defect-free image or one or more classes of defect images. Thus, by setting the class label to OK label 536, a sample OK image may be generated by the diffusion model. Similarly, by setting the class label to label NG 535, a sample NG image corresponding to a type of defect image may be generated by the diffusion model 440. Thus, in some embodiments, the diffusion model sampling circuit 510 may utilize variables \hat{x}ₜ_{₁} denoting the sampled defect image \hat{x}ₜ_{₁} 555 at time step t₁ and \tilde{x}ₜ_{₁} denoting the sampled defect-free image \tilde{x}ₜ_{₁} 556 at time step t₁.

According to some embodiments, the sampling process implemented by the diffusion model sampling circuit 510 may start by taking a defect-free image 402 of the target product, and noise (e.g., Gaussian noise) corresponding to some intermediate time step t=t₀ may be added to the defect-free image 402 to generate the noisy image 522. Once noise has been added to the image, the label NG 535 (also referred to as an NG label) corresponding to the class for defects and OK label 536 corresponding to the class for defect-free may be set for the diffusion model 440, and the noise may be removed in an iterative denoising process. Using the diffusion model 440, through denoising steps, sampling by selecting the label NG 535 may generate sampled defect image \hat{x}ₜ_{₁} 555 and sampling by selecting the label OK 536 may generate the sampled defect-free image \tilde{x}ₜ_{₁} 556 for a preceding time step (e.g., t₀₋₁) for time steps t₀≥t>t₁.

In addition, the diffusion model sampling circuit 510 may generate the mask 531 during this process. For example, at time step t=t₁, the diffusion model sampling circuit 510 may determine a difference between the sampled defect image \hat{x}ₜ_{₁} 655 and the sampled defect-free image \tilde{x}ₜ_{₁} 556 (e.g., difference between pixels in grayscale) for time steps t₀≥t>t₁. The process for generating the mask 531 implemented by the diffusion model sampling circuit 510 may be represented mathematically by:

$${\sum }_{{t}_{0 - 1}}^{{t}_{0}} ‖ {\hat{x}}_{t - 1} - {\tilde{x}}_{t - 1} ‖ = γ \qquad ( eq . 1 )$$

where t denotes a time step, \hat{x}ₜ₋₁ denotes the sampled defect image \hat{x}ₜ₁ 655 at time step t=t−1, and \tilde{x}ₜ₋₁ denotes the sampled defect-free image \tilde{x}ₜ_{₁} 656 at time step t=t−1, and γ denotes a defined threshold.

The difference between the sampled defect image \hat{x}ₜ_{₁} 555 and the sampled defect-free image \tilde{x}ₜ_{₁} 556 may indicate a particular location and/or area in the image where the defect 532 is expected to be generated. By comparing the samples having defects and the samples that are defect-free, the diffusion model 440 may be capable of predicting a more focused location and/or area in the image (e.g., depicting portion of a circuit board illustrating traces) for generating the defect 532. That is, the mask 531 may define a particular location and/or area within an image for more precise generation of the synthetic defect 532. In some embodiments, the mask 531 may include parameters that define one or more characteristics related to generating the defect 532 in the synthetic defect image 408, including by not limited to: location; size; shape; size; intensity; and/or the like.

In some embodiments, the diffusion model sampling circuit 510 may continue the sampling process at time step t=t₁ now applying the generated mask 531 to the denoising process. For example, the diffusion model sampling circuit 510 may perform denoising for the remaining steps of the sampling process using the mask 531 to confine generating the defect 532 to the defined location in the image. Denoising can continue by removing some of the noise from the noisy image 522 by sampling for a defect using the label NG 535 at each time step but overlaying the mask 531 on the sampled image to zero out the areas outside of the mask 531. For instance, additional sampled defect images can be generated with locations outside of the mask 531 are zeroed out in the grayscale. In some embodiments, denoising utilizing the mask 531 can be iteratively performed by the diffusion model sampling circuit 510 for time steps t₁≥t>0. Accordingly, denoising with the mask 531 results in an image where noise corresponding to generating the defect 532 is restricted to the particular location (e.g., defined by the mask 531) in the image. Additionally, the background 533 from the higher quality defect-free image 402 can be copied over to generate and/or replace areas in the additional sampled defect images that are outside of the mask 531. Thus, through these denoising steps, a high quality synthetic defect image 408 can be generated that includes the defect 532 (e.g., class selected by the label NG 535) generated within the location defined by the mask 531 (e.g., using diffusion model sampling), while having clarity maintained by utilizing the high quality background 533. Therefore, the denoised imaged at step t=0 is the synthetic defect image 408 for a target product that has been enhanced through automatic masking.

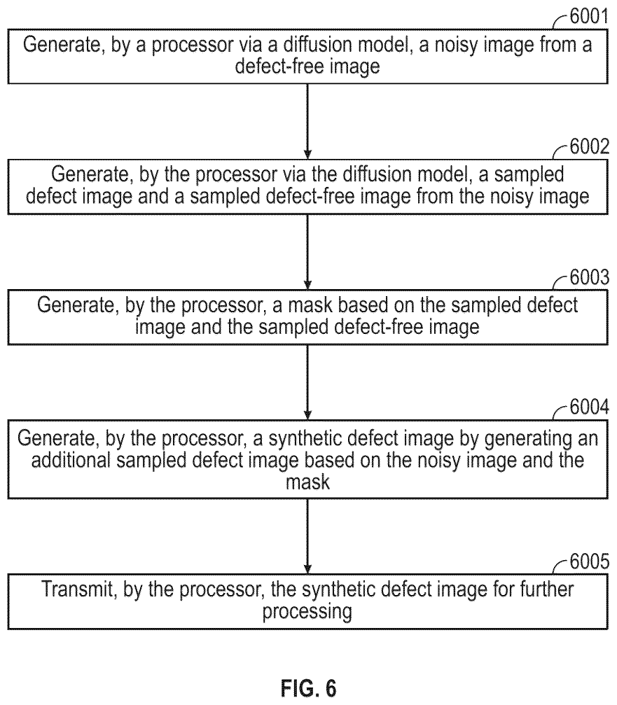

FIG. 6 is a flow chart depicting example operations of a method for synthetic defect image generation using diffusion model sampling, and including automatic masking, according to some embodiments of the present disclosure.

Referring to FIG. 6 the method 6000 may include one or more of the following operations. A processor 502 (see FIG. 5), via a diffusion model 440, may generate a noisy image 522 from a defect-free image 402 (operation 6001). A processor 502, via the diffusion model 440, may generate sampled defect image \hat{x}ₜ₁ 555 and sampled defect-free image \tilde{x}ₜ_{₁} 556 from the noisy image 522 (see FIG. 5) (operation 6002). The processor 502 may generate a mask 531 based on the sampled defect image \hat{x}ₜ₁ 555 and the sampled defect-free image \tilde{x}ₜ_{₁} 556 (see FIG. 5) (operation 6003). A processor 502 may generate a synthetic defect image 408 by generating an additional defect sampled image based on the noisy image 522 and the mask 531 (see FIG. 5), and the synthetic defect image may include a defect generated within a location defined by the mask (operation 6004). The processor 502 may transmit the synthetic defect image 408 for further processing, by another processor or module of the processor (operation 6005).

Accordingly, aspects of some embodiments of the present disclosure may provide advancements over conventional defect generation and/or manual masking approaches (e.g., inaccuracy, slowness, low repeatability, etc.) by implementing diffusion model sampling using distinct automatic masking aspects such to improve the accuracy and/or efficiency of the generation of synthetic defect images.

FIG. 7 is a block diagram of an electronic device in a network environment 700, according to some embodiments of the present disclosure.

Referring to FIG. 7, an electronic device 701 in a network environment 700 may communicate with an electronic device 702 via a first network 798 (e.g., a short-range wireless communication network), or an electronic device 704 or a server 708 via a second network 799 (e.g., a long-range wireless communication network). The electronic device 701 may communicate with the electronic device 704 via the server 708. The electronic device 701 may include a processor 720 (e.g., one or more processing circuits or means for processing), a memory 730, an input device 750, a sound output device 755, a display device 760, an audio module 770, a sensor module 776, an interface 777, a haptic module 779, a camera module 780, a power management module 788, a battery 789, a communication module 790, a subscriber identification module (SIM) card 796, or an antenna module 797. In one embodiment, at least one (e.g., the display device 760 or the camera module 780) of the components may be omitted from the electronic device 701, or one or more other components may be added to the electronic device 701. Some of the components may be implemented as a single integrated circuit (IC). For example, the sensor module 776 (e.g., a fingerprint sensor, an iris sensor, or an illuminance sensor) may be embedded in the display device 760 (e.g., a display).

The processor 720 may execute software (e.g., a program 740) to control at least one other component (e.g., a hardware or a software component) of the electronic device 701 coupled with the processor 720 and may perform various data processing or computations.

As at least part of the data processing or computations, the processor 720 may load a command or data received from another component (e.g., the sensor module 776 or the communication module 790) in volatile memory 732, process the command or the data stored in the volatile memory 732, and store resulting data in non-volatile memory 734. The processor 720 may include a main processor 721 (e.g., a central processing unit (CPU) or an application processor (AP)), and an auxiliary processor 723 (e.g., a graphics processing unit (GPU), an image signal processor (ISP), a sensor hub processor, or a communication processor (CP)) that is operable independently from, or in conjunction with, the main processor 721. Additionally, or alternatively, the auxiliary processor 723 may be adapted to consume less power than the main processor 721, or execute a particular function. The auxiliary processor 723 may be implemented as being separate from, or a part of, the main processor 721.

The auxiliary processor 723 may control at least some of the functions or states related to at least one component (e.g., the display device 760, the sensor module 776, or the communication module 790) among the components of the electronic device 701, instead of the main processor 721 while the main processor 721 is in an inactive (e.g., sleep) state, or together with the main processor 721 while the main processor 721 is in an active state (e.g., executing an application). The auxiliary processor 723 (e.g., an image signal processor or a communication processor) may be implemented as part of another component (e.g., the camera module 780 or the communication module 790) functionally related to the auxiliary processor 723.

The memory 730 may store various data used by at least one component (e.g., the processor 720 or the sensor module 776) of the electronic device 701. The various data may include, for example, software (e.g., the program 740) and input data or output data for a command related thereto. The memory 730 may include the volatile memory 732 or the non-volatile memory 734. Non-volatile memory 734 may include internal memory 736 and/or external memory 738.

The program 740 may be stored in the memory 730 as software, and may include, for example, an operating system (OS) 742, middleware 744, or an application 746.

The input device 750 may receive a command or data to be used by another component (e.g., the processor 720) of the electronic device 701, from the outside (e.g., a user) of the electronic device 701. The input device 750 may include, for example, a microphone, a mouse, or a keyboard.

The sound output device 755 may output sound signals to the outside of the electronic device 701. The sound output device 755 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 760 may visually provide information to the outside (e.g., a user) of the electronic device 701. The display device 760 may include, for example, a display, a hologram device, or a projector and control circuitry to control a corresponding one of the display, hologram device, and projector. The display device 760 may include touch circuitry adapted to detect a touch, or sensor circuitry (e.g., a pressure sensor) adapted to measure the intensity of force incurred by the touch.

The audio module 770 may convert a sound into an electrical signal and vice versa. The audio module 770 may obtain the sound via the input device 850 or output the sound via the sound output device 755 or a headphone of an external electronic device 702 directly (e.g., wired) or wirelessly coupled with the electronic device 701.

The sensor module 776 may detect an operational state (e.g., power or temperature) of the electronic device 701 or an environmental state (e.g., a state of a user) external to the electronic device 701, and then generate an electrical signal or data value corresponding to the detected state. The sensor module 776 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 777 may support one or more specified protocols to be used for the electronic device 701 to be coupled with the external electronic device 702 directly (e.g., wired) or wirelessly. The interface 777 may include, for example, a high-definition multimedia interface (HDMI), a universal serial bus (USB) interface, a secure digital (SD) card interface, or an audio interface.

A connecting terminal 778 may include a connector via which the electronic device 701 may be physically connected with the external electronic device 802. The connecting terminal 778 may include, for example, an HDMI connector, a USB connector, an SD card connector, or an audio connector (e.g., a headphone connector).

The haptic module 779 may convert an electrical signal into a mechanical stimulus (e.g., a vibration or a movement) or an electrical stimulus which may be recognized by a user via tactile sensation or kinesthetic sensation. The haptic module 779 may include, for example, a motor, a piezoelectric element, or an electrical stimulator.

The camera module 780 may capture a still image or moving images. The camera module 780 may include one or more lenses, image sensors, image signal processors, or flashes. The power management module 788 may manage power supplied to the electronic device 701. The power management module 788 may be implemented as at least part of, for example, a power management integrated circuit (PMIC).

The battery 789 may supply power to at least one component of the electronic device 701. The battery 789 may include, for example, a primary cell which is not rechargeable, a secondary cell which is rechargeable, or a fuel cell.

The communication module 790 may support establishing a direct (e.g., wired) communication channel or a wireless communication channel between the electronic device 701 and the external electronic device (e.g., the electronic device 702, the electronic device 704, or the server 708) and performing communication via the established communication channel. The communication module 790 may include one or more communication processors that are operable independently from the processor 720 (e.g., the AP) and supports a direct (e.g., wired) communication or a wireless communication. The communication module 790 may include a wireless communication module 792 (e.g., a cellular communication module, a short-range wireless communication module, or a global navigation satellite system (GNSS) communication module) or a wired communication module 794 (e.g., a local area network (LAN) communication module or a power line communication (PLC) module). A corresponding one of these communication modules may communicate with the external electronic device via the first network 798 (e.g., a short-range communication network, such as BLUETOOTH™, wireless-fidelity (Wi-Fi) direct, or a standard of the Infrared Data Association (IrDA)) or the second network 799 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 792 may identify and authenticate the electronic device 701 in a communication network, such as the first network 898 or the second network 799, using subscriber information (e.g., international mobile subscriber identity (IMSI)) stored in the subscriber identification module 796.

The antenna module 797 may transmit or receive a signal or power to or from the outside (e.g., the external electronic device) of the electronic device 701. The antenna module 797 may include one or more antennas, and, therefrom, at least one antenna appropriate for a communication scheme used in the communication network, such as the first network 798 or the second network 799, may be selected, for example, by the communication module 790 (e.g., the wireless communication module 792). The signal or the power may then be transmitted or received between the communication module 790 and the external electronic device via the selected at least one antenna.

Commands or data may be transmitted or received between the electronic device 701 and the external electronic device 704 via the server 708 coupled with the second network 799. Each of the electronic devices 702 and 704 may be a device of a same type as, or a different type, from the electronic device 701. All or some of operations to be executed at the electronic device 701 may be executed at one or more of the external electronic devices 702, 704, or 708. For example, if the electronic device 701 should perform a function or a service automatically, or in response to a request from a user or another device, the electronic device 701, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 701. The electronic device 701 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
generating, by a processor via a diffusion model, a noisy image from a defect-free image;
generating, by the processor via the diffusion model, a sampled defect image and a sampled defect-free image from the noisy image;
generating, by the processor, a mask based on the sampled defect image and the sampled defect-free image;
generating, by the processor, a synthetic defect image by generating an additional sampled defect image based on the noisy image and the mask; and
transmitting, by the processor, the synthetic defect image.

2. The method of claim 1, wherein the defect-free image comprises a real defect-free image of a target product.

3. The method of claim 1, wherein the generating the sampled defect image comprises sampling the diffusion model based on a first class label set to a defect label.

4. The method of claim 3, wherein the generating the sampled defect-free image comprises sampling the diffusion model based on a second class label set to a defect-free label.

5. The method of claim 4, wherein the generating the sampled defect image and the sampled defect-free image comprises sampling the diffusion model for a set of time steps in an iterative process.

6. The method of claim 1, wherein the generating the mask comprises determining a difference between the sampled defect image and the sampled defect-free image.

7. The method of claim 1, wherein the generating the synthetic defect image comprises generating a defect within a location defined by the mask and overlaying the mask over the additional sampled defect image.

8. The method of claim 1, wherein the generating the synthetic defect image comprises replacing a background of the synthetic defect image outside of a location defined by the mask.

9. The method of claim 8, wherein the replacing the background of the synthetic defect image is performed based on the defect-free image.

10. The method of claim 1, wherein the synthetic defect image comprises a synthetic defect image of a target product and the defect-free image of the target product.

11. The method of claim 1, wherein the generating the synthetic defect image comprises denoising an amount of noise within a location defined by the mask.

12. The method of claim 11, wherein the denoising is performed for the additional sampled defect image for a set of time steps.

13. The method of claim 1, wherein the diffusion model is trained based on a real defect-free image and a real defect image.

14. The method of claim 13, wherein the real defect-free image and the real defect image are associated with a source product.

15. A device comprising:
one or more processors that are configured to perform:
generating a sampled defect image and a sampled defect-free image from a noisy image using a diffusion model;
generating a mask based on the sampled defect image and the sampled defect-free image;
generating a synthetic defect image by generating an additional sampled defect image based on the noisy image and the mask; and
transmitting the synthetic defect image.

16. The device of claim 15, wherein the one or more processors are configured to perform the generating the sampled defect image by sampling the diffusion model using a first classification set to a defect label.

17. The device of claim 16, wherein the one or more processors are configured to perform the generating the sampled defect-free image by sampling the diffusion model using a second classification set to a defect-free label.

18. The device of claim 17, wherein the one or more processors are configured to perform the generating the sampled defect image and the sampled defect-free image by sampling the diffusion model for a set of time steps in an iterative process.

19. The device of claim 15, wherein the one or more processors are configured to perform:
the generating the mask by determining a difference between the sampled defect image and the sampled defect-free image; and
the generating the synthetic defect image by generating a defect within a location defined by the mask.

20. A system comprising:
a processing circuit; and
a memory storing instructions, which, based on being executed by the processing circuit, cause the processing circuit to perform:
generating a noisy image from a defect-free image based on a diffusion model;
generating a sampled defect image and sampled defect-free image from the noisy image based on the diffusion model;
generating a mask based on the sampled defect image and the sampled defect-free image;
generating a synthetic defect image by generating an additional sampled defect image based on the noisy image and the mask; and
transmitting the synthetic defect image.
